(19) United States
(12) Patent Application Publication
(10) Pub. No.: US 2018/0050328 A1
(43) Pub. Date: Feb. 22, 2018

(54) MODIFIED POROUS HYPERCROSSLINKED POLYMERS FOR CO2 CAPTURE AND CONVERSION

(71) Applicant: Agency for Science, Technology and Research, Singapore (SG)

(72) Inventors: Yugen Zhang, Singapore (SG); Jinquan Wang, Singapore (SG)

(21) Appl. No.: 15/555,189

(22) PCT Filed: Apr. 15, 2016
(86) PCT No.: PCT/SG2016/050178

§ 371 Date: Sep. 1, 2017

(30) Foreign Application Priority Data
Apr. 15, 2015 (SG) 10201502968P

(51) Int. Cl. B01J 31/06; C08G 83/00; C08G 61/02; C08J 9/36; B01J 35/10; B01J 37/00; B01D 53/86; B01D 53/83

(52) U.S. Cl. CPC B01J 31/06; C08G 2101/00; C08G 61/02; C08J 9/36; B01J 35/1023; B01J 35/1028; B01J 35/1057; B01J 35/1061; B01J 37/00; B01D 53/8671; B01D 53/83; C08G 2261/132; C08G 2261/135; C08G 2261/516; C08G 2261/72; C08G 2261/149; C08G 2261/143; C08G 2261/45; C08G 83/006

(57) ABSTRACT

The present disclosure describes a process for making a hyperporous material for capture and conversion of carbon dioxide. The process comprises the steps a first self-polymerisation of benzyl halides via Friedel-Crafts reaction. In the second step the obtained hypercrosslinked polymer is further coupled with an amine or heterocyclic compound having at least one nitrogen ring atom. The invention also relates to the material obtained to the process and its use in catalytic reactions, for instance the conversion of epoxides to carbonates. Salt-modified porous hypercrosslinked polymers obtained according to the invention show a high BET surface (BET surface area up to 926 m²/g) combined with strong CO₂ capture capacities (14.5 wt %). The nitrogen compound functionalized hypercrosslinked polymer catalyst shows improved conversion rates compared to known functionalized polystyrene materials and an excellent recyclability. A new type of imidazolium salt modified polymers shows especially high capture and conversion abilities. Carbonates can be produced in high yields according to the inventive used of the obtained polymers.

### TECHNICAL FIELD

The present invention relates to a process for making a hypercrosslinked, porous polymer material by self-polymerisation of benzyl halides and coupling with nitrogen containing moieties. The polymer material obtained from the process can be used a catalyst under heterogeneous conditions for conversions of substrates by reaction with a captured gas.

### BACKGROUND ART

Porous materials modified with imidazolium salts have received wide attentions as they have potential applications in the fields of catalysis, gas separation as well as energy related technology. According to current techniques imidazolium salts are mainly immobilized onto the surface of porous inorganic materials, such as silica or metal oxides. Immobilization of imidazolium salts onto porous organic materials has received significantly less attention, due to the difficulties in synthesis of such materials. Although microporous main-chain imidazolium organic framework and vinylimidazolium/divinyl-benzene based hypercrosslinked side-chain imidazolium porous materials are known, these synthetic methods largely depend on the specific pre-functionalized imidazolium groups and/or other expensive starting materials. These complicated procedures are unlikely to be used in large scale application. Hence, developing a practical method for the synthesis of imidazolium-modified porous organic materials from easily available starting materials is highly desirable.

The global climate change and the excessive CO₂ emission have attracted widespread public concern in recent years. The combination of CO₂ capture and conversion is an attractive strategy for reducing CO₂ emissions. Porous materials can capture and store CO₂ in their pore structure. The CO₂ density in the pore could be tens to hundreds of times higher than gaseous CO₂ under ambient atmosphere. To this end, functionalized porous materials with both porous characteristics and active catalytic sites could provide potential synergistic effect for CO₂ transformation. Recently, few porous materials with metal catalytic centres have been identified as promising materials to fulfil the requirement. These include the salen-based organic polymer via multi-step synthesis as solid ligand and Mg-MOF via sonochemical synthesis. However, metal-free porous organic materials functionalized for both CO₂ capture and conversion have not been known so far.

There is therefore a need to provide a metal-free, porous material functionalized for both CO₂ capture and conversion that overcomes or at least ameliorates, one or more of the disadvantages described above.

Recently, considerable attentions have been devoted to developing functional materials for CO₂ capture. Both microporosity and functionalization have been identified as important characteristics for gas adsorption. But the currently available materials are not satisfactory with regard to the achieved properties. Imidazolium salts as organocatalyst for the conversion of CO₂ into cyclic carbonate have attracted significant interest. Organic polymer supported imidazolium salts as the stable and recyclable heterogeneous catalysts are especially highlighted. However, no fully satisfactory performing materials consisting of porous polymer-supported imidazolium salts have been found.

Recently, Friedel-Crafts polymerization has provided a new method for preparing hypercrosslinked aromatic porous polymers, and these polymer materials have received considerable interests due to their ease in preparation, high chemical and thermal stability, and low cost. These polymers have demonstrated potentials for CO₂ capture, however, hydrophobic hypercrosslinked ones show better performance under more realistic “wet” conditions. The synthetic approach is based on the one-step Friedel-Crafts alkylation between aromatic monomers and formaldehyde dimethyl acetal. Although this approach has been successfully applied to some simple aromatics, there are still limitations with regard to substrate scope, especially for monomers with specific functionalized groups. This has become the main obstacle for application of porous hypercrosslinked polymers in catalysis.

There is therefore a need to provide methods for making specifically functionalized hypercrosslinked polymers in catalysis.

### SUMMARY

In first aspect, there is provided a process for making a hypercrosslinked, porous polymer material comprising the steps of (a) a self-polymerisation of benzyl halides via Friedel-Crafts reaction, and (b) coupling of an amine or heterocyclic compound having at least one nitrogen ring atom to the obtained polymer.

In another aspect, there is provided a process according to the invention wherein the heterocyclic compound is an optionally substituted heterocyclic compound having 5 or 6 ring atoms and 1 to 3 hetero atoms in the optionally benzofused ring and is coupled to the polymer to form a salt.

Advantageously, the hypercrosslinked polymer of the Friedel-Crafts reaction in step (a) can be functionalized with an amine or heterocyclic compound to form a salt and then shows a high capability of carbon dioxide (CO₂) capturing. The reaction can be done in a simple and controllable way. Further advantageously, the new multi-functional materials can be synthesized using easily available starting materials that may be suitable for large scale application.

The obtained porous materials display a large BET surface area (up to 926 m²/g) and exhibit excellent CO₂ capture capacity (14.5 wt %, 273 k and 1 bar). In addition, the modified porous materials demonstrated high stability and reusability for both CO₂ capture and conversion.

Further advantageously, the captured carbon dioxide can be used for the conversion of other compounds, such as epoxides, to form a carbon dioxide addition product, such as a cyclic carbonate.

In one embodiment, the heterocyclic compound is an optionally substituted imidazole which is used in its imidazolium salt form when coupled to the polymer matrix.

Advantageously, the supported imidazolium salts displayed much higher activities than homogeneous and traditional poly-styrene (PS) supported imidazolium salts for the conversion of CO₂. The materials obtained using the inventive process showed significantly higher activities for the conversion of CO₂ into various cyclic carbonates. A synergistic effect of micro porosity of porous materials and functionality of imidazolium salts for CO₂ capture and catalytic conversion was found.

In one type of embodiments the benzyl halide is selected from a compound of the formula (I), (II) or (III), or mixtures of compounds of these compounds

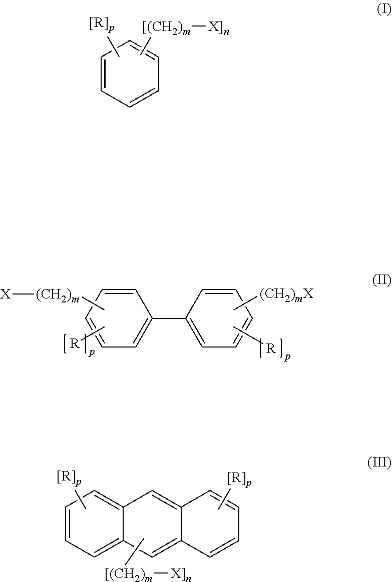

wherein X is a hydroxyl group (OH) or halogen, and at least one X is halogen,
R is independently selected from the group consisting of hydrogen, halogen, C₁-C₃-alkyl or halgeno-C₁-C₃-alkyl; m is 1, 2, 3 or 4; n is 1, 2 or 3; and p is 0, 1 or 2.

Advantageously, this type of imidazolium salt-modified porous hypercrosslinked polymers was synthesized by Friedel-Crafts reaction from benzyl halides and subsequently functionalized with an imidazole. The benzyl halide monomers provided both a functional handle for direct crosslinkage via Friedel-Crafts reaction, as well as opportunities for further modification towards different applications.

In another aspect, there is provided the hypercrosslinked polymer material obtainable in the process of the invention.

Advantageously this material is stable in hot water. No polymer degrading is observed and the CO₂ capture capacity of polymer kept the same after hot water treatment. Due to its pore size it shows the observed CO₂ capture and conversion reaction catalysis capability.

In another aspect, there is provided the use of the hypercrosslinked polymer material obtainable in the process of the invention as a catalyst for conversion reactions in the presence of a gas.

Advantageously the use as a catalyst in such reactions leads to high conversion yields making the material an alternative heterogeneous organocatalyst compared to known functionalized porous organic polymers. The catalysed reactions, for instance the conversion of epoxides to cyclic carbonates, proceed well under relatively mild conditions. The catalyst materials made by the inventive process demonstrate much higher activities than the conventional polystyrene supported materials under the same reaction conditions. Further advantageously, the catalyst can be recycled after such reactions without loss of activity after several recycling cycles.

### Definitions

The following words and terms used herein shall have the meaning indicated:

The term “hypercrosslinked” as used herein refers to a type of multiple crosslinking that results in a rigid three-dimensional network.

The term “porous material”, for the purposes of this application, refers to a material containing pores (voids). The skeletal portion of the material is called the “matrix”. The pores may be filled with a gas or liquid.

The term “polymer” for the purposes of this application, refers to a large molecule, or macromolecule, composed of many repeated subunits.

The term “Friedel-Crafts reaction” for the purposes of this application, refers to a well-known reaction type developed by Charles Friedel and James Crafts to attach substituents to an aromatic ring by electrophilic aromatic substitution and includes the two main types of Friedel-Crafts reactions: alkylation reactions and acylation reactions. Alkylation may be preferably used in the invention.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF OPTIONAL EMBODIMENTS

Exemplary, non-limiting embodiments of a the process according to the invention and the materials obtained by such process will now be disclosed.

The invention relates to a process for making a hypercrosslinked, porous polymer material comprising the steps of (a) self-polymerisation of benzyl halides via Friedel-Crafts reaction, and (b) coupling of an amine or heterocyclic compound having at least one nitrogen ring atom to the obtained polymer.

Step (a) is a Friedel-Crafts reaction. The benzyl halide monomer units are self-polymerized in this reaction. The benzyl halides can be of a single type or can be mixtures of different benzyl halides. A benzyl halide is characterized by having a benzyl moiety and a halogen group in the alkyl part of the benzyl.

The benzyl halides according to this invention disclosure are defined broadly. They include unsubstituted and optionally substituted benzyl halides. A substituted benzyl halide is a benzyl halide bearing one or more substituent(s) on the aromatic ring. Such substituent may be inert in the process. Optional substituents that can be mentioned include phenyl, phenyl C₁-C₃-alkyl, phenoxy, halo, nitro, cyano, C₁-C₃-alkyl-cyano, C₁-C₆-alkyl, halogeno-C₁-C₃-alkyl, —COO—C₁-C₃-alkyl, C₁-C₆-alkyl-OH, C₂-C₆-alkenyl-OH, C₁-C₆-alkyl-SH, C₂-C₆-alkenyl-SH or a C₄-C₆-alkyldiyl-bridge. CH₂—OH may be especially mentioned as optional substituent. Methyl-halogen group may be further extended by methylene linkers.

The benzyl halides may be additionally benzofused. The halogen in the benzyl halide can be selected from fluorine, chlorine, bromine or iodine. It may be chlorine or bromine. Preferably it may be chlorine.

Benzyl halides wherein the aromatic core is bis-substituted with two groups selected from CH₂—OH and/or CH₂-halogen may be preferred. A benzyl halide with at least one CH₂—OH group may be especially mentioned.

In one type of embodiments the benzyl halide is selected from a compound of the formula (I), (II), or (III), or mixtures of compounds of these compounds

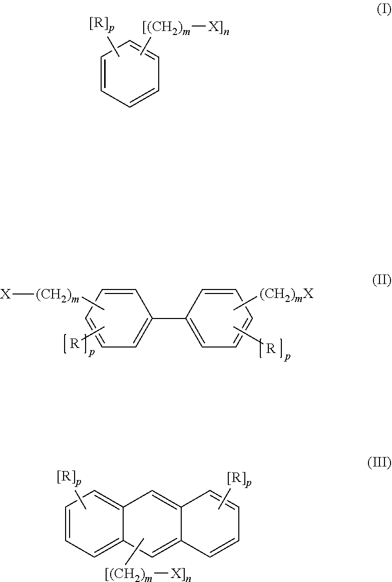

wherein X is a hydroxyl group (OH) or halogen, and at least one X is halogen,
R is independently selected from the group consisting of hydrogen, halogen, C₁-C₃-alkyl or halgeno-C₁-C₃-alkyl;
m is 1, 2, 3 or 4;
n is 1, 2 or 3;
and p is 0, 1 or 2.

If n or p are >1, then R, X and m can be chosen independently for the substituents. At least one X may be chlorine or bromine. In one embodiment, one X of several X substituents stands for chlorine and another X substituent stands for chlorine or a hydroxyl group. In another embodiment one X substituent in formula (I) is OH and n is preferably 2 or 3.

n may be 2. p may be 0. At least one m may be 1 or all m may be 1. R may be independently selected from the group consisting of hydrogen, chlorine, bromine, methyl or trifluoromethyl.

The benzyl halide may be selected from the group consisting of benzyl chloride, benzyl bromide, α,α′-dichloroxylene, α,α′-dibromoxylene, (Chloromethyl)benzyl alcohol, 4,4′-bis(chloromethyl)-1,1′-biphenyl and 9,10-bis(chloromethyl)anthracene.

As solvents for the Friedel-Crafts reaction typical anhydrous organic solvents known from text book literature relating to this reaction type can be used. Halogenated hydrocarbons, such as dichloromethane or dichloroethane, and carbon disulfide may be specifically mentioned. The reaction may be performed at elevated temperatures. The elevated temperature may be in the range of about 50 to 120° C., it may preferably be in the range of about 70 to 90° C. A strong Lewis acid may be used as the catalyst in the reaction of step (a). Such strong Lewis acids include ferric halides, such as FeCl₃, or aluminum halides, such as AlCl₃. The Lewis acid may be used in molar excess to the benzyl halides, such as in about 0.5- to 5-fold, 0.7- to 3-fold or 1 to 2-fold excess. The reaction time may be several hours to several days. Preferably the reaction is performed for 12 to 36 hours. The polymerization product of step (a) may be separated off and purified before use in step (b). The reaction product can be separated after the reaction by known separation techniques, such as filtration or centrifugation. The product may be further purified, for instance by Soxhlet extraction in polar organic solvents, such as alcohols. It may be dried before further use.

The polymeric product obtained in step (a) may contain halogen groups. Preferably it may contain at least 1, 2, 5, 10 or 20% by weight of halogen from elemental analysis. Preferably it may contain a maximum of 25 or 30% by weight of halogen from elemental analysis.

Step (b) of the inventive process is a coupling step. An amine or heterocyclic compound having at least one nitrogen ring atom is coupled to the polymeric product obtained in step (a).

The coupling may take place between halogen groups of the polymer material obtained in step (a) and an active site on the amine or N-heterocyclic compound. The active site may be a tertiary nitrogen atom of the amine or N-heterocyclic compound. The coupling takes place in an inert organic solvent, such as xylene, diethylbenzene, benzene, ethylene dichloride, toluene or cumene. The coupling may result in a chemical bond between the amine or heterocyclic compound and the polymeric material and a salt formation.

The reaction of step (b) may be performed at elevated temperatures. The elevated temperature may be in the range of 50 to 120° C., it may preferably be in the range of 70 to 90° C. The reaction may be performed in the absence of a base or acid and result in the formation of salts. The amine or N-heterocyclic compound may be used in about equimolar amounts or in excess. Preferably the amine or N-heterocyclic compound is used in molar excess to the halogen groups introduced into the polymer matrix; it may be used in about 0.5- to 10-fold, 0.7- to 5-fold or 1 to 3-fold excess. Most preferably it may be used in about 0.8- to 2-fold excess. The reaction time may be several hours to several days. Preferably the reaction is performed for 12 to 36 hours.

The N-alkylation and salt formation may not need to achieve full completion. Reaction products wherein the substitution rate of the halogen is between about 10% to 99%, about 15% to 70%, or about 17% to 60% may be used.

The nitrogen content of the separated and dried reaction product is then about 0.2% to 5%, or about 1% to 4% or about 1.5% to 3% by weight from elemental analysis. The carbon content may typically be about 65 to 90% or about 70 to 85% by weight from elemental analysis. The hydrogen content may typically be about 3 to 6% or about 3.5 to 5% by weight from elemental analysis. The loading of amine or heterocyclic compound may be of about 0.1 to about 5 mmol/g of final polymer product, preferably about 0.1 to about 10 mmol/g, or 0.3 to about 3 mmol/g, most preferably about 0.5 to about 2 mmol/g.

The reaction is followed by washing steps using polar organic solvents, such as methanol. The final product may be vacuum-dried at elevated temperatures (about 30 to 70° C.) after the washing steps.

The heterocyclic compound in step (b) may be an optionally substituted heterocyclic compound having 5 or 6 ring atoms and 1 to 3 hetero atoms in the optionally benzofused ring. The heterocyclic compound may be coupled to the polymer to form a salt. The hetero atoms may be selected from N, O or S with at least one hetero atom being nitrogen. The optional substituents of the heterocyclic group may be selected from the group of C₁-C₄-alkyl, C₁-C₄-alkoxy, halo-C₁-C₄-alkyl, halo-C₁-C₄-alkyloxy, amino-C₁-C₄-alkyl, hydroxyl-C₁-C₄-alkyl, halo, cyano, and nitro. The heterocyclic compound may have at least one tertiary nitrogen atom. Preferably the tertiary nitrogen atom is a ring atom substituted by a C₁-C₄-alkyl. The alkyl may be methyl.

The heterocyclic group may be an optionally C₁-C₄-alkyl, halogen, cyano or nitro substituted pyrrole, pyrrolidine, pyrroline, piperidine, imidazole, imidazoline, imidazolidine, tetrazole, triazole, pyrazole, pyrazoline, pyrazolidine, oxazole, isoxazole, thiazole, morpholine, thiomorpholine, piperazine or isothiazole. Preferably the compounds are used as N-alkyl derivatives. The substituent on the nitrogen atom may be a C₁-C₄-alkyl. The C₁-C₄-allyl may itself be substituted. As substituents for C₁-C₄-alkyl there can be mentioned as an example: phenyl, —CH₂—COOH, CH₂—COO—C₁-C₄-alkyl. Preferably the heterocyclic group is heteroaromatic.

The heterocyclic group may be an optionally C₁-C₄-alkyl, halogen, cyano or nitro substituted pyrrole, imidazole, pyrazole, oxazole, isoxazole, thiazole or isothiazole.

This heterocyclic group may be additionally benzofused to form an optionally substituted benzofused heterocyclic compound. It may be selected from indole, isoindole, indoline, tetrahydroquinoline, benzimidazole, phenoxazine, phenothiazine or indazole. The heterocyclic group may alternatively be heteroaromatic-fused to form an optionally substituted heteroaromatic-fused heterocyclic compound. It may be selected from optionally substituted purine. A heterocyclic compound that is an optionally 1-(N-)substituted imidazole may be particularly mentioned. The substituent of this 1-substituted imidazole may be methyl, ethyl, propyl, butyl, nitro, chlorine or bromine. The N-substituent is preferably selected from methyl, ethyl, propyl or butyl.

After coupling, all the amines and heterocyclic groups may be in salt form. They may be in the form of their halogen salts, such as for instance chlorides or bromides.

The amine in step (b) may be an optionally substituted tertiary amine with 1 to 18 carbon atoms. The substituents may be aliphatic or aromatic. As examples there may be mentioned: NR′₃ wherein R′ is selected independently from C₁-C₆-alkyl, C₁-C₆-alkyl-OH, phenyl or benzyl.

In another aspect, there is provided the hypercrosslinked polymer material obtainable or obtained in the process of the invention.

This material may comprise a hypercrosslinked network of polymerized benzyl moieties.

Additionally the network may comprise as substituents-(CH₂)ₘ-halogen groups that have been, totally or in part, coupled to an amine or heterocyclic compound by reaction with the halogen. In these substituent groups m represents 1, 2, 3 or 4, preferably 1, and the halogen is selected from fluorine, chlorine, bromine or iodine; preferably it may be bromine or chlorine, most preferably chlorine. The network may additionally comprise as substituents —CH₂—OH groups.

The numbers of —(CH₂)ₘ—X groups before the coupling with the amine or heterocyclic compounds preferably represent a halogen content of about 1% to 30%, of about 2% to 30%, of about 5% to 25% or of about 10 to 25% by weight from elemental analysis of the whole material obtained in step (a). Between about 10% to 99%, about 15% to 70%, or about 17% to 60% of the —(CH₂)ₘ—X groups may be used for coupling with the amine or heterocylic compound to form the polymer material according to the invention in step (b).

The amine and heterocyclic compounds are those described above for the process of the invention. The amine or heterocyclic compound is preferably in salt form after coupling. It may be in the form of a halogen salts. It may be a chloride or bromide salt. The loading with amine or heterocyclic compound may be about 0.1 to 10 mmol/g, about 0.3 to 3 mmol/g, most preferably about 0.5 to 2 mmol/g of the polymer material.

The hypercrosslinked polymer material according to the invention has a large BET surface. The material may have a BET surface area of about 450 to 1500 m²/g or about 500 to 1500 m²/g or about 500 to 1000 m²/g calculated in a relative pressure range of P/P₀=0.01 to 1. Preferred materials may have a BET surface area of about 600 to 950 m²/g calculated in a relative pressure range of P/P₀=0.01 to 1.

The hypercrosslinked polymer material according to the invention, especially those coupled to imidazolium salts, show the ability for high CO₂ uptake. The material may show a CO₂ uptake of about 5 to 25% by weight or 10 to 15% by weight, most preferably 13 to 15% by weight (all by BET at 273 k and 1 bar).

The hypercrosslinked polymer material according to the invention is a porous material. The material may be microporous with additional meso (>2.0 nm) or macro pores. The material may comprise pores of a pore size of about 0.1 to about 50 nm, preferably 0.1 to 10 nm, more preferably 0.1 to 5 nm. The pore distribution of the material may be predominantly in the range of a micro pore size of about 0.1 to 2.5 nm, preferably about 0.5 to 2 nm, more preferably about 0.7 to 1.8 nm. A material which substantially has micro pores in these ranges may be especially mentioned.

The hypercrosslinked material according to the invention has a high total pore volume and micro pore volume. The total pore volume may be about 0.3 to 1.5 cm³/g or preferably about 0.5 to 2 cm³/g. The micropore volume may be about 0.05 to 0.5 cm³/g or preferably about 0.1 to 0.2 cm³/g.

In yet another aspect of the invention, the use of the hypercrosslinked polymer material as a catalyst for conversion reactions in the presence of a gas is provided. Due to the porosity of the material it can be applied as catalyst involving reactions of a substrate with a gas. The polymer material matrix catalyzes the reaction with the substrate to form a new product. The catalysis may be a heterogeneous catalysis involving the polymer material used in a solution of the substrate in the presence of a gas.

The heterogeneous conversion reaction may be performed in two steps. The steps may comprise (a) carbon dioxide capture and (b) carbon dioxide conversion. The gas is then first captured in the pores of the polymeric material according to the invention and then made available for the conversion reaction.

The conversion reaction may be carried out optionally in the presence of a solvent, at high pressure, optionally under stirring and optionally at elevated temperatures. A reaction temperature of about 70 to 150° C. may be used. A pressure above 0.1 MPa, preferably above 0.8 MPa, may be applied. The reaction time may be 0.5 to 8 hours. The formed cyclic carbonate is then isolated from the reaction mixture by conventional methods.

The gas may be carbon dioxide that reacts with the substrate. The substrate of the conversion reaction may be an epoxide that reacts to a cyclic carbonate. As suitable epoxides there can be mentioned for example an epoxide selected from the group consisting of ethylene oxide, propylene oxide, propylene oxide, cyclohexene oxide, styrene oxide and butylene oxide. These epoxides may be optionally substituted. As substituents there can be mentioned as examples C₁-C₂₀-alkyl, C₂-C₁₂-alkenyl, C₂-C₁₂-alkinyl, C₁-C₂₀-alkoxy, halo-C₁-C₂₀-alkyl, halo-C₁-C₂₀-alkyloxy, amino-C₁-C₄-alkyl, hydroxyl-C₁-C₄-alkyl, halo, cyano, nitro, phenyl-C₁-C₂₀-alkyl, phenyloxy. Chlorine may be particularly emphasized as a substituent. The cyclic carbonates may be selected from the group consisting of optionally substituted ethylene carbonate, propylene carbonate, butylene carbonate, styrene carbonate and cyclohexene carbonate. Using the polymer material according to the invention the selectivity for the cyclic carbonate is high. Yields of 60 to 95% are obtained. In preferred embodiments of the inventive use yields may be higher than 90% or even 92%. The cyclic carbonate may be obtained is a liquid.

The heterogeneous reaction may be performed in a solvent. A polar solvent may be used. The solvent may be selected from the group consisting of ethyl acetate, methanol, ethanol and propanol.

The coupled amine or heterocyclic compound may support the conversion reaction. An imidazolium salt coupled to the polymer material may support the conversion reaction of epoxides to carbonates as a catalyst. The polymer material according to the invention is applied in catalytic amounts. The catalytic amount may be chosen from 1 to 50 mmol % compared to the catalytic molar concentration of the amine or heterocyclic compound coupled on the matrix.

The polymer catalyst can be recycled for further use after the conversion reaction. It may be easily separated from products by centrifugation/filtration and reused without purification with no or very little loss in activity.

In another aspect of the invention the carbonate obtained by the conversion reaction of epoxide substrates is also provided.

### BRIEF DESCRIPTION OF DRAWINGS

The accompanying drawings illustrate a disclosed embodiment or serve to explain the principles of the disclosed embodiment. It is to be understood, however, that the drawings are designed for purposes of illustration only, and not as a definition of the limits of the invention.

FIG. 1 refers to the various synthesis schemes of supported imidazolium salts and the typical structure of POM-IM.

FIG. 2 refers to a solid-13C NMR spectrum for POM1-IM

FIG. 3 refers to an FT-IR spectrum for POM1-IM

FIG. 4 refers to an the thermogram of POM1-IM by TGA

FIG. 5 refers to the N₂ adsorption and desorption isotherms for the obtained porous organic polymers POM1 and POM1-IM at 77 K.

FIG. 6 refers to a pore size distribution for POM3-IM calculated using NLDFT

FIG. 7 refers to a TEM image of POM1-IM.

FIG. 8 refers to the obtainable yield using recycled catalyst (reaction conditions: PO (1.43 mmol), POM3-IM (5 mmol % based on the imidazolium salt), Ethanol (2 ml), CO₂ pressure (1 MPa), Temperature (120° C.), Time (4 h).

### EXAMPLES

Non-limiting examples of the invention and a comparative example will be further described in greater detail by reference to specific Examples, which should not be construed as in any way limiting the scope of the invention.

### Materials and Methods

The 1-methylimidazole, 1,4-bis (chloromethyl) benzene, 1,2-bis (chloromethyl) benzene and iron chloride were provided by Sigma-Aldrich. The chloromethyl polystyrene was purchased from Fluka, and the epoxides were purchased from the VWR international. GC-MS were measured on SHIMADZU-QP2010. GC analyses were performed on an Agilent GC-6890 using a flame ionization detector. NMR spectra were recorded on a Bruker 400. N₂ sorption analysis and CO₂ sorption analysis were performed on a Micromeritics Tristar 3000 (77 and 273 K, respectively). TEM experiments were conducted on a FEI Tecnai G2 F20 electron microscope (200 kV). TGA was performed on a Perkin-Elmer Pyris-1 thermogravimetric analyzer. Elemental analysis (CHNS) was performed on an Elementarvario MICRO cube. FT-IR experiments were performed on a Perkin Elmer Spectrum 100. Solid-13C NMR experiments were conducted at a Bruker Avance 400 (DRX400) with CP/MAS.

The calculations were carried out by performing DFT by use of the B3PW91 functional with the 6-31++G (d, p) basis set as implemented in Gaussian 03 program package. The solvent effect uses the Conductor Polarizable Continuum Model (CPCM) in each case. Vibrational frequency calculations, from which the zero-point energies were derived, have been performed for each optimized structure at the same level to identify the natures of all the stationary points. All the bond lengths are in angstroms (Å). Structures were generated using CYLview (CYLview, 1.0b; C. Y. Legault, Universite de Sherbrooke, 2009 (http://www.cylview.org).

The CO₂ experiments were performed on a Belsorp-mimi II at 273 and 298 K. Before each measurement, the samples were heated at 150° C. in vacuum for 24 h. TGA gas capture experiments were conducted on a on a Perkin-Elmer Pyris-1 thermogravimetric analyzer. Porous carbons (5 mg) were subjected to the following gas capture and cycling experiment at 25° C.: CO₂ (99.8%) gas flow at 20 mL min⁻¹ for 30 min, followed by N₂ (99.9995%) gas flow at 20 mL min⁻¹ for 45 min. Changes in weight were recorded by using TGA. Prior to the cyclic treatment, the sample was first purged under N₂ gas flow at 200° C. for 60 min, followed by cooling to room temperature. Change in buoyancy effects arising from the switching of gases was recorded by using an empty sample pan, and the buoyancy effects were corrected for in the TGA results. For the adsorption kinetics analysis, the porous carbon was first purged under Ar gas flow (20 mL min⁻¹) at 200° C. for 60 min, followed by cooling to room temperature. The gas was then switched from Ar to CO₂ or N₂ (20 mL min⁻¹). The selectivity of CO₂ over N₂ is calculated by the saturated absorption according to reported work by Fuertes (M. Sevilla and A. B. Fuertes, Energy Environ. Sci., 2011, 4, 1765).

### Example 1: Synthesis of the Hyperporous Functonalized Polymer

The benzyl halide-functionalized organic polymers were synthesized according to methods generally known from C. D. Wood, B. Tan, A. Trewin, H. Niu, D. Bradshaw, M. J. Rosseinsky, Y. Z. Khimyak, N. L. Campbell, R. Kirk, E. Stockel and A. I. Cooper, Chem. Mater., 2007, 19, 2034 and C. F. Martin, E. Stockel, R. Clowes, D. J. Adams, A. I. Cooper, J. J. Pis, F. Rubiera, C. Pevida, J. Mater. Chem., 2011, 21, 5475. Typically, iron (III) chloride (120 mmol) was added to a solution of benzyl halide compound (60 mmol) in anhydrous dichloroethane (80 ml). The resulting mixture was heated at 80° C. for 24 h. When the reaction was completed, the solid product was centrifuged and washed with methanol (3×20 mL). The product was further purified by Soxhlet extraction in methanol for 20 h and dried in vacuum at 60° C. for 24 h. The polymers were obtained in quantitative yields. The content of chloride or bromide in the obtained polymers was determined by elemental analysis (Table 1). The polymers were further reacted with N-methylimidazole (molar ratio of Cl:N-methylimidazole=1:2) in 20 ml toluene at 80° C. for 24 h, the resultant supported imidazolium salts were washed with methanol (3×20 ml) and dried in vacuum at 60° C. for 24 h. From elemental analysis results, the modification was not completed for most of samples.

TABLE 1

| | C | H | Cl | Br |
|---|---|---|---|---|
| POM | (wt %) | (wt %) | (wt %) | (wt %) |
| POM1 | 74.53 | 4.56 | 24.13 | / |
| POM2 | 74.71 | 4.42 | 10.70 | / |
| POM3 | 76.81 | 4.76 | 5.61 | / |
| POM4 | 71.43 | 3.92 | / | 6.8 |
| POM5 | 71.91 | 4.35 | / | 1.5 |
| POM6 | 87.42 | 5.05 | <0.5 | / |

Table 1 refers to the elemental analysis results for POM1˜6.

### Synthesis Imidazolium Salt

A mixture of benzyl chloride (12 mmol), 1-methylimidazole (10 mmol) and toluene (10 mL) was heated at 80° C. for 24 h in a 25 mL flask with vigorous stirring. After cooled down to room temperature, the solid residue washed with benzene (3×5 mL) and ethyl acetate (3×5 mL). Then, the solid was dried under vacuum at 60° C. for 12 h and the imidazolium salt was obtained.

### Comparative Example: Synthesis of Polystyrene Resin Supported Imidazolium Salt

Polystyrene (PS) resin supported imidazolium salt was made according to a method generally known from J. Sun, W. G. Cheng, W. Fan, Y. H. Wang, Z. Y. Meng, and S. J. Zhang, Catal. Today, 2009, 148, 361-367). A mixture of chloromethyl polystyrene (1.0 g, 5.5 mmol Cl content), 1-methylimidazole (16.5 mmol) and toluene (10 mL) was heated at 80° C. for 24 h in a 25 mL flask with vigorous stirring. After cooled down to room temperature, the solid residue was collected by filtration and washed with methanol (3×5 mL). Then, the solid was dried under vacuum at 60° C. for 12 h and polystyrene resin supported imidazolium salt was obtained. The loading of imidazolium salt attached on the PS was 3.6 mmol/g determined by nitrogen content from elementary analysis.

### Example 2: CO₂ Capture

Imidazolium salt-modified porous hypercrosslinked polymers were subjected to the following gas capture and cycling experiment at 25° C.: CO₂ (99.8%) gas flow at 20 ml/min for 30 min, followed by N₂ (99.9995%) gas flow at 20 ml/min for 45 min. Changes in weight were recorded by TGA. Prior to the cyclic treatment, the sample was first purged under N₂ gas flow at 100° C. for 60 min, followed by cooling to room temperature. Change in buoyancy effects arising from the switching of gases was recorded by using an empty sample pan, and the buoyancy effects were corrected.

For the adsorption kinetics analysis of CO₂ and N₂, the porous supported imidazolium salt was first purged under Ar gas flow (20 ml/min) at 100° C. for 60 min, followed by cooling to room temperature. The gas was then switched from Ar to CO₂ or N₂ (20 ml/min).

### Example 3: CO₂ Conversion

CO₂ conversion reactions were conducted in a 50 ml stainless steel reactor equipped with a magnetic stirrer and automatic temperature control system. Typically, an appropriate volume of CO₂ (1.0 MPa) was added to a mixture of propylene oxide (PO) (0.1 ml), ethanol (2 ml), porous supported imidazolium salt (5 mmol % based on contents of the imidazolium salt) in the reactor at room temperature. The temperature was then raised to 120° C. After the reaction was preceded for 4 h, the reactor was cooled to 0° C. in an ice water bath, and the remaining CO₂ was slowly removed.

The product was then analysed by GC and NMR. The porous supported imidazolium salts could be easily separated by centrifugation, and used in the next run without further purification.

### Results Using the Material and Methods of the Examples

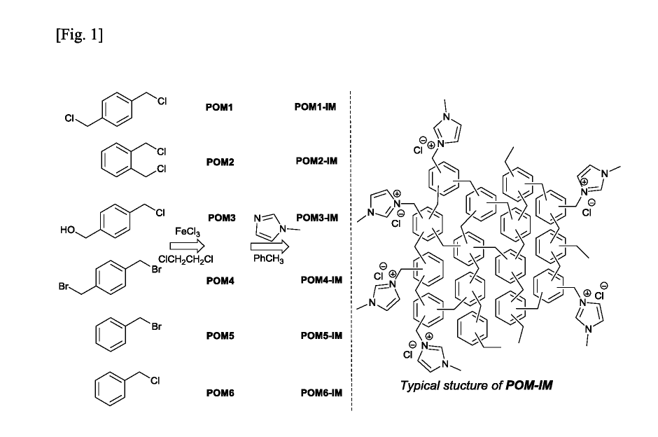

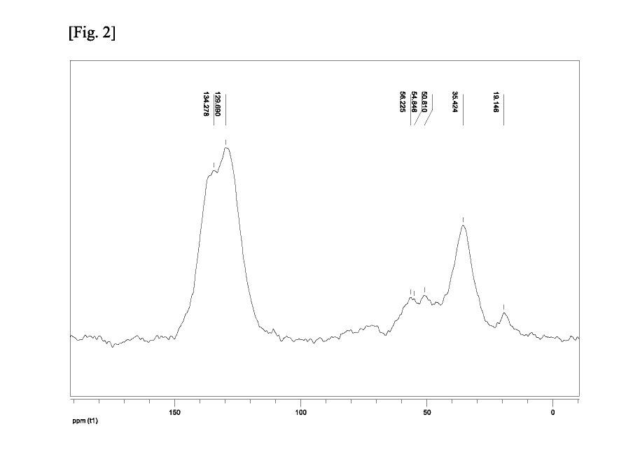

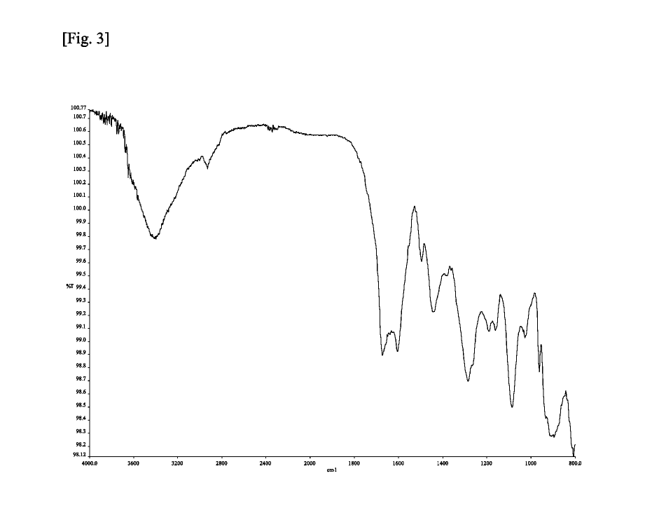

The synthetic approach to imidazolium-modified porous hypercrosslinked polymers of the examples is shown in FIG. 1. The monomers were directly self-polymerized via Friedel-Crafts reactions. The resultant polymers with remaining benzyl chloride (or benzyl bromide) groups were further reacted with N-methylimidazole. All the polymers were produced as insoluble dark brown solids in yields over 90% on a typical scale of 10 g per batch. The materials were characterized by 13C NMR (solid-state), FT-IR and elemental analysis. The resolved resonance around 129 ppm and 134 ppm was found and is assumed to correspond to the aromatic carbons of the benzene ring and imidazole ring (FIG. 2). A signal around 35 ppm was assumed to the methylene carbon formed via Friedel-Crafts reaction. In FT-IR spectra, the presence of imidazolium salts was confirmed by strong absorption bands around 1600 cm¹ (FIG. 3). The nitrogen content of porous materials from bis-substituted monomers was determined by elemental analysis to be about 1.8 to 2.8 wt % (imidazolium loading 0.6 to 1.0 mmol/g, Table 2).

TABLE 2

| | C | H | N | Degree of halogen |
|---|---|---|---|---|
| POM | (wt %) | (wt %) | (wt %) | substitution (%) |
| POM1-IM | 74.36 | 4.85 | 2.01 | 11% |
| POM2-1M | 75.41 | 4.69 | 2.01 | 23% |
| POM3-IM | 72.11 | 5.06 | 2.84 | 63% |
| POM4-IM | 68.04 | 4.44 | 1.85 | 78% |
| POM5-IM | 80.74 | 5.13 | 1.19 | >99% |
| POM6-IM | 71.89 | 4.63 | <0.50 | — |
| POM3-IM^{a} | 72.22 | 5.04 | 2.82 | |

^{a}After six runs

Table 2 refers to Elemental analysis results for POM1˜6-IM.

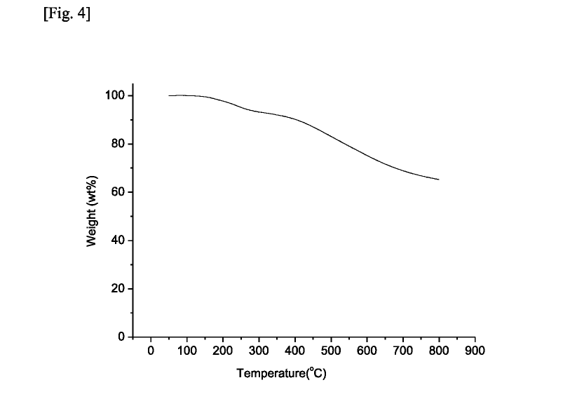

Polymers synthesized from mono-substituted monomers gave much lower nitrogen loading, especially for POM6-IM. Thermal gravimetric analysis (TGA) shows that all porous organic materials (POM1˜6 and POM1˜6-IM) have excellent thermal stability (FIG. 4, POM1-IM as example).

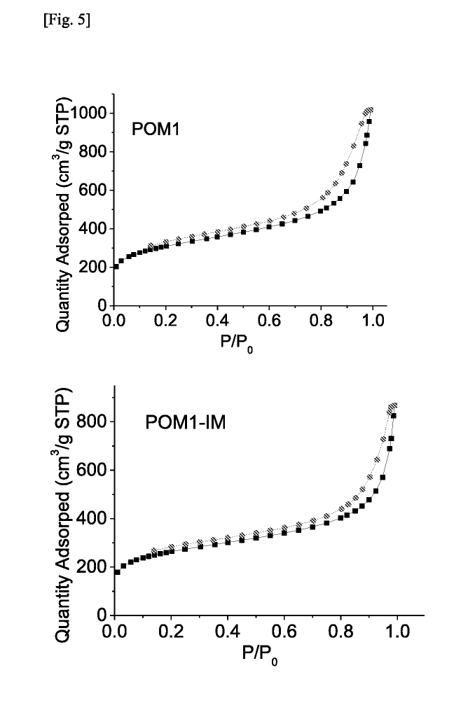

The porosities of the original porous polymers (POM) and imidazolium salt functionalized porous polymers (POM-IM) were evaluated by N₂ adsorption-desorption isotherms (FIG. 5).

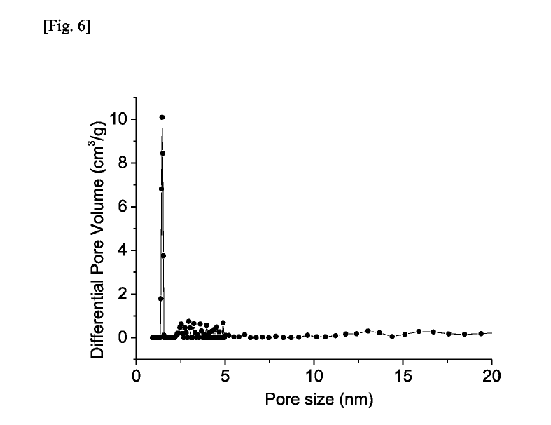

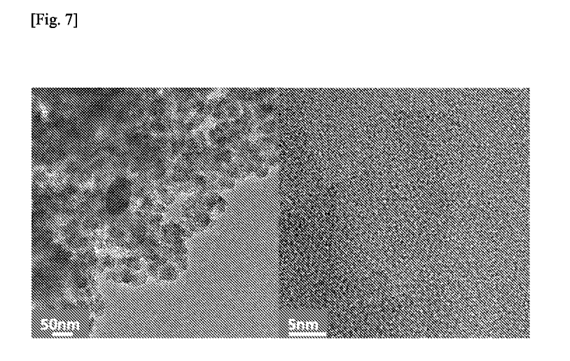

The micro pore size distributions of these materials are predominantly around 1.4 nm (FIG. 6, POM3-IM as an example). However, also meso- and macrostructures (>2.0 nm) were observed based on related isotherms curves. The transmission electron microscopy (TEM) image of POM1-IM also demonstrated a uniform micro pore (FIG. 7). The textural properties of the first-step polymers (POM1˜6) and imidazolium modified polymers are shown in the Table 3. The BET surface areas for the imidazolium modified porous polymers are in the range of 99 and 926 m²/g. The total pore volume and the micro pore volume are as high as 1.06 cm³/g and 0.17 cm³/g, respectively. The BET surface area and pore volume of the imidazolium-modified polymers are similar or lower than the respective original polymers (POM1˜6-IM vs POM1˜6). In addition, the porosity of the materials from bis-substituted precursors (POM 1-4) is much larger than those from mono-substituted precursors (POM 5-6), as bis-substituted precursors could form more crosslinks during the reaction. As for the choice of halide, benzyl chloride resulted in better porous materials than corresponding benzyl bromide (POM 5 vs 6).

TABLE 3

| | S_{BET}^{a}/ | S_{micro}^{b}/ | Vₜₒₜₐₗ^{b} | V_{micro}/ | CO₂ uptake^{c}/wt % |
|---|---|---|---|---|---|
| Polymers | m²/g | m²/g | cm³/g | cm³/g | (273K) |
| POM1 | 1089 | 390 | 1.31 | 0.17 | 13.8 |
| POM2 | 1047 | 486 | 0.82 | 0.22 | 13.0 |
| POM3 | 1088 | 563 | 0.71 | 0.26 | 16.4 |
| POM4 | 752 | 418 | 0.54 | 0.19 | 12.4 |
| POM5 | 81 | 0 | 0.75 | 0 | 3.8 |
| POM6 | 664 | 297 | 0.45 | 0.13 | 9.5 |
| POM1-IM | 926 | 373 | 1.06 | 0.17 | 13.9 |
| POM2-IM | 653 | 335 | 0.51 | 0.15 | 14.5 |
| POM3-IM | 575 | 334 | 0.39 | 0.15 | 14.2 |
| POM4-IM | 632 | 375 | 0.48 | 0.17 | 10.6 |
| POM5-IM | 50 | 0 | 0.12 | 0 | 5.7 |
| POM6-IM | 659 | 278 | 0.45 | 0.12 | 5.5 |
| POM3-IM^{d} | 530 | 320 | 0.32 | 0.12 | 14.2 |

Table 3 refers to the physical properties for the porous organic materials (^{a}The BET surface area was calculated in a relative pressure range P/P0=0.01-1. ^{b}The micropore surface area Sm, and micropore volume V_{micro} were estimated from the t-plot method. ^{c}Measured at 273 k and 1 bar. ^{d}after six runs.)

According to the examples it has been found that materials derived from bis-substituted benzenes exhibited better CO₂ capture capacity (10.6˜14.5 wt % by BET at 273 K and 1 bar and 4.6˜4.8 wt % by TGA at 298 K and 1 bar). The CO₂ capture capacity of different polymers is closely correlated with micro pore volumes and load of imidazolium salts. In general, the introduction of functional groups decreased its porosity of the material (such as BET surface area and pore volume), as well as CO₂ capture capacity. For imidazolium-modified polymers (POM1, 2, 4, 5-IM), their porosities are indeed decreased. Surprisingly, their CO₂ capture capacities were kept in the same range or slightly increased (Table 3). On the contrary, the CO₂ capacities of POM3-IM and POM6-IM were lower than that of POM3 and POM6 possibly because of the significant decrease in BET surface area and pore volume in these two cases. POM3 has highest CO₂ capture capacity due to its high micro pore volume and the presence of hydroxyl group. Polymers derived from mono-substituted monomers (benzyl chloride and benzyl bromide) have a bit lower CO₂ capture capacities. The heat of absorption for POM1˜3-IM is 25.6, 31.1 and 31.5 kJ/mol, respectively. But, these materials have fast adsorption rate, over 97% of CO₂ was adsorbed within 8 min. The CO₂ and N₂ selectivity of these materials is as high as 13 at the equilibrium conditions. The CO₂ adsorption of these materials is fully reversible. The polymer made according to the inventive process is stable in hot water. No polymer degrading was observed and the CO₂ capture capacity of polymer kept the same after hot water treatment (80° C., 18 h). Although the CO₂ capture capacity of current materials is not the highest as comparing to other “knitted” polymer, this imidazolium modified porous polymer provides an excellent opportunity to look for the synergistic effect of CO₂ capture and conversion.

In addition, polymers are more hydrophilic after being modified by imidazolium salts, which is also beneficial for CO₂ conversion. The catalytic activities of the synthesized porous hypercrosslinked polymer-supported imidazolium salts were tested for the conversion of CO₂ and propylene oxide (PO) into propylene carbonate (PC). Surprisingly, these materials (POM-IM) demonstrated much higher activities than the conventional PS supported materials under the same reaction conditions (entry 1 vs 7, Table 4). The catalytic activities of POM1-IM and POM3-IM were even higher than the homogeneous imidazolium catalyst (entry 1 vs 8). This may be attributed to the synergistic effect of the micro pore structure and the catalytic centres which are located in the pore structure. The polymers could capture and concentrate CO₂, which results in a 20 higher CO₂ concentration near catalytic centres and makes the catalytic reaction more efficient. To prove this, reactions under low CO₂ pressure (0.2 MPa vis 1 MPa) were carried out. As shown in Table 4, POM3-IM retained more than half of its original catalytic activity at low CO₂ pressure (42% yield vis 78% 25 yield), while PS-IM and homogeneous BMIC almost lost all their catalytic activities (entries 9-11). 42% yield of POM3-IM catalyst at 0.2 MPa is higher than PS-IM (30%) and close to BMIC catalysts (49%) under 1 MPa. The total pore volume of POM3-IM is 0.39 cm³. It can capture more than 0.5 wt % (5 mg/g) of CO₂ at 120° C. under 0.1 MPa. 5 mg of CO₂ will occupy more than 3 cm³ volume (vis 0.39 cm³ total pore volume) at 120° C. under 0.1 MPa. This could explain the high activity of POM3-IM and further confirmed that the micro pore structure does play an important role in imidazolium salt catalysed CO₂ transformation. In addition, the catalytic activity of polymers was generally corresponded to their BET surface area and halide loading. No activity was observed for POM6-IM due to the low contents of imidazolium salts (entry 6).

TABLE 4

| Entry | Cat. | PO conv.^{b} (%) | PC yield^{b} (%) |
|---|---|---|---|
| 1 | POM1-IM | 59 | 58 |
| 2 | POM2-IM | 46 | 46 |
| 3 | POM3-IM | 78 | 78 |
| 4 | POM4-IM | 40 | 40 |
| 5 | POM5-IM | 38 | 38 |
| 6 | POM6-11V1 | Trace | Trace |
| 7^{c} | PS-IM | 30 | 30 |
| 8^{d} | BMIC | 49 | 49 |
| 9^{e} | POM3-IM | 42 | 42 |
| 10^{e} | BMIC | 6 | 6 |
| 11^{e} | PS-IM | 5 | 5 |

Table 4 refers to the activities of supported imidazolium salts for the conversion of CO₂ with propylene oxide into propylene carbonate^{a} (^{a}Reaction conditions: PO (1.43 mmol), catalyst (5 mmol % based on the imidazolium salt), ethanol (2 ml), CO₂ pressure (1 MPa), 120° C., 4 h. ^{b}Yield and conversion were determined by GC using biphenyl as the internal standard. ^{c}PS=polystyrene resin. ^{d}BMIC=1-benzyl-3-methylimidazolium chloride. ^{e}CO₂ pressure (0.2 MPa).)

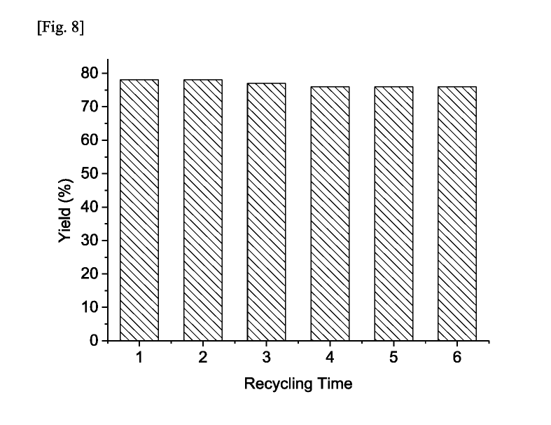

Surprisingly, POM3-IM, which has hydroxyl functionality in its framework, demonstrated the highest activity among them for the conversion of CO₂ with PO to propylene carbonate (entry 4 vs 1 and 2). It is believed that the high activity of this material is due to the hydrogen bond interactions between hydroxyl groups and reactants. Recycling experiments indicated that the POM-IM materials have excellent stability and recyclability. It was reused for six runs and no obvious loss in activity was observed (FIG. 8). FT-IR spectra of POM3-IM catalyst before and after the reaction did not show any notable difference which further supported the stability of the porous POM-IM materials. The stability of reused polymeric catalyst is further verified by N₂ adsorption and elemental analysis, the surface area changed slightly from 575 to 530 cm²/g (Table 3), and the contents of nitrogen has no obvious decrease.

Quantum calculations were also carried out to investigate the reaction mechanism with 1-benzyl-3-methylimidazolium chloride as the model catalyst. The calculation was conducted by use of the B3PW91 functional with the 6-311++G (d, p) basis set as implemented in Gaussian 09 program package. The catalytic cycle was presumed to occur in three steps.

The first step is ring-opening through the attack of the nucleophile (Cl—from imidazolium salt) on epoxide, which was considered to be the most difficult step with the largest activation energy (ΔE=21.25 kcal/mol). The second step was the insertion of CO₂. The last step was the formation of cyclic carbonate with activation energy of 19.3 kcal/mol. This catalytic cycle involving C(2)-H of imidazolium salt activation process is exothermic with low activation barrier, which allows the reaction to be performed under mild condition. The reaction mechanism of POM3-IM with hydroxyl group was also studied using 1-benzyl-3-methylimidazolium chloride and benzyl alcohol as the model system. A double activation process with both C(2)-H of the imidazolium salt and hydroxyl group of benzyl alcohol may be proposed. This double activation process further decreased the activation energy, especially for the ring-opening step (18.35 vis 21.25 kcal/mol).

The epoxide substrate scope was screened using POM3-IM as the catalyst. As shown in Table 5, the catalytic system was found to be effective for a variety of terminal epoxides (entries 1-8). Furthermore, epoxides functionalized with alkene or long hydrophobic chain were also suitable substrates for this catalytic system (entries 5-8). Compared with other reported functionalized porous organic polymers the POM-IM is indeed very promising as a heterogeneous organocatalyst for two respects: the catalysts were synthesized in a simple and easily controllable way, and the reactions proceeded well under relatively mild condition.

TABLE 5

| | | | Time/ | Conv./ | Yield/ |
|---|---|---|---|---|---|
| Entry | Epoxide | Product | h | %^{b} | %^{b} |
| 1 | 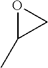 | 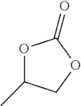 | 8 | 94 | 92 |
| 2 | 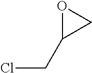 | 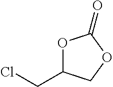 | 8 | 96 | 90 |
| 3 | 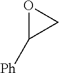 | 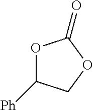 [SMILES: O=C1OCC(c2ccccc2)O1] | 12 | 90 | 89 |
| 4 | 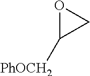 | 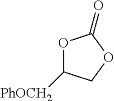 | 12 | 91 | 91 |
| 5 | 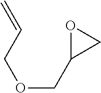 | 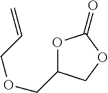 | 12 | 76 | 73 |
| 6 | 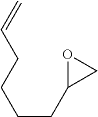 | 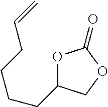 | 12 | 70 | 68 |
| 7 | 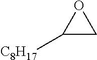 | 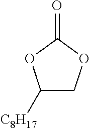 | 30 | 98 | 93 |
| 8 | 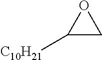 | 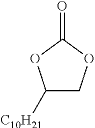 | 30 | 86 | 85 |

Table 5 refers to the substrate scope in the conversion reactions. (^{a}Reaction condition: Epoxide (1.43 mmol), POM3-IM (5 mmol % based on the imidazolium salt), ethanol (2 ml), CO₂ pressure (1 MPa), Temperature (120° C.), every experiment was conducted in triplicate. ^{b}Yield and conversion were determined by NMR.

### INDUSTRIAL APPLICABILITY

The hypercrosslinked material made according to the process of the present disclosure may be useful in catalysis involving CO₂ as gaseous reagents due to its high ability to capture CO₂ and its ability to convert chemical compounds with the captured CO₂. The process allows for the conversion of CO₂ and epoxides to cyclic carbonates in high yields.

The materials obtained by the process according to the invention demonstrate high stability and reusability for both CO₂ capture and conversion and may find use in industrial catalysis at larger scales.

Due to their capture abilities the hypercrosslinked material made according to the process of the invention may be useful in other applications in which a gas, ion, atom or molecule or needs to be captured. Such applications could include water treatment or heavy metal removal.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A process for making a hypercrosslinked, porous polymer material comprising the steps of:
(a) a self-polymerisation of benzyl halides via Friedel-Crafts reaction, and
(b) coupling of an amine or heterocyclic compound having at least one nitrogen ring atom to the obtained polymer.

2. The process of claim 1, wherein the heterocyclic compound in step (b) is an optionally substituted heterocyclic compound having 5 or 6 ring atoms and 1 to 3 hetero atoms in the optionally benzofused ring and is coupled to the polymer to form a salt.

3. The process of claim 2, wherein the heterocyclic compound is an optionally benzofused, optionally heteroaromatic fused and optionally C₁-C₄-alkyl, halogen, cyano or nitro substituted pyrrole, pyrrolidine, pyrroline, piperidine, imidazole, imidazoline, imidazolidine, tetrazole, triazole, pyrazole, pyrazoline, pyrazolidine, oxazole, isoxazole, thiazole, morpholine, thiomorpholine, piperazine or isothiazole.

4. The process of claim 1, wherein the heterocyclic compound is an optionally 1-substituted imidazole.

5. The process of claim 1, wherein the benzyl halide is selected from a compound of the formula (I), (II), (III) or mixtures of compounds of these compounds 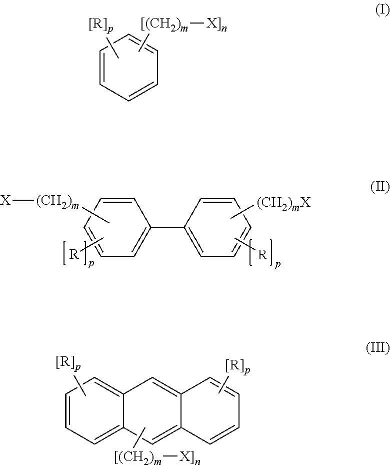
wherein X is a hydroxyl group (OH) or halogen, and at least one X is halogen;
R is independently selected from the group consisting of hydrogen, halogen, C₁-C₃-alkyl or halgeno-C₁-C₃-alkyl;
m is 1, 2, 3 or 4;
n is 1, 2, or 3;
p is 0, 1 or 2.

6. The process of claim 5, wherein the benzyl halide is a compound of formula (I), m is 1, n is 2 and p is 0.

7. The process of claim 5, wherein one X stands for chlorine and others stand for chlorine or a hydroxyl group.

8. The process of claim 1, wherein in step (a) a strong Lewis acid is used.

9. The process of claim 8, wherein the Lewis acid is selected from ferric halides.

10. The process of claim 1, wherein the Friedel-Crafts reaction in step (a) is performed at elevated temperatures, in an anhydrous organic solvent in the presence of a strong Lewis acid, and the coupling step (b) is performed in an inert organic solvent at elevated temperatures.

11. The process of claim 10, wherein the polymerization product of step (a) is separated off and purified before use in step (b).

12. The hypercrosslinked polymer material obtainable in the process of claim 1.

13. The hypercrosslinked polymer material of claim 12, having a BET surface area of about 500 to 1500 m²/g, calculated in a relative pressure range of P/P₀=0.01 to 1.

14. The hypercrosslinked polymer material of claim 12, having pores of a pore size of about 0.1 to 50 nm.

15. The hypercrosslinked polymer material of claim 14, predominantly having micropores of a pore size of about 0.1 to 2 nm.

16. Use of the material according to claim 12 as a catalyst for conversion reactions in the presence of a gas.

17. The use of claim 16, wherein the coupled amine or heterocyclic compound supports the conversion reaction.

18. The use of claim 16, wherein the conversion reaction comprises the steps of:
(a) carbon dioxide capture; and
(b) carbon dioxide conversion.

19. The use of claim 18 wherein an epoxide group of a substrate compound is converted to a carbonate group.

20. The use of claim 16, wherein the catalyst is recycled for further use after the conversion reaction.
